(19) United States
(12) Patent Application Publication
(10) Pub. No.: US 2007/0222932 A1
(43) Pub. Date: Sep. 27, 2007

(54) BISTABLE LIQUID CRYSTAL DISPLAY DEVICE

(75) Inventors: David Sikharulidze, Bristol (GB); Stephen Christopher Kitson, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/689,901

(22) Filed: Mar. 22, 2007

(30) Foreign Application Priority Data
Mar. 22, 2006 (GB) 0605697.2

(51) Int. Cl. G02F 1/1337

(52) U.S. Cl. 349/129

(57) ABSTRACT

A bistable liquid crystal display device comprises: a first cell wall (1) and a second cell wall (1′) enclosing a layer of a nematic liquid crystal material (5) and electrodes (2, 2′) for applying an electric field across at least some of the liquid crystal material (5). A first alignment structure is provided on an inner surface of the first cell wall (1), comprising a grating (3) which tends to induce adjacent molecules of the liquid crystal material (5) to adopt a uniform planar alignment substantially without pre-tilt. A second alignment structure is provided on an inner surface of the second cell wall (1′), comprising an array of posts (4) or holes which tend to induce adjacent molecules of the liquid crystal material (5) to adopt a uniform planar alignment with pre-tilt.

The surface of the second alignment structure has a higher anchoring strength than does the surface of the first alignment structure, and two stable molecular configurations of the liquid crystal material (5) can exist after suitable electrical signals have been applied to the electrodes (2, 2′).

Other aspects of the invention provide a method of manufacturing the device and a method of addressing the device.

### RELATED APPLICATIONS

The present application claims priority to GB Application Number 0605697.2 filed Mar. 22, 2006, the disclosure of which is hereby incorporated by reference herein in its entirety.

### FIELD OF THE INVENTION

An aspect of the present invention relates to a bistable liquid crystal display device comprising a nematic liquid crystal between microstructured surfaces. The device is switchable between different optical states by suitable electrical pulses. Other aspects of the invention provide a method of manufacturing the device and a method of electrically addressing the device.

### BACKGROUND OF THE INVENTION

The development of intrinsic bistability in nematic liquid crystals is a promising route towards the creation of displays with low power consumption, simple driving and high resolution. At the same time there is a requirement for displays with higher brightness than conventional displays. High brightness and bistability are key features for the development of paper-like displays. Other desirable features are large area fabrication and fabrication using substrates of a plastics material (“plastic technology”).

In ‘Mechanically Bistable Liquid-Crystal Display Structures’, R N Thurston et al, IEEE Trans. on Elec. Devices, Vol. ED-27, No. 11, November 1980, there are described two bistable nematic LC modes which are called ‘vertical-horizontal’ and ‘horizontal-horizontal’. In the vertical-horizontal mode, both cell walls are treated to give a roughly 45° tilt which permits the directors to be switched between two states in a plane which is perpendicular to the major surfaces of the device. In the horizontal-horizontal mode, the director is switchable between two angles in a plane parallel to the major surfaces of the device.

For large area fabrication it is desirable to use manufacturing methods which are compatible with plastic technology, for example the use of microstructured alignment layers which can be applied by embossing or photoresist techniques. At present there are several types of bistable device based on microstructured alignment layers. One type is known as the zenithal bistable device (ZBD): Bryan-Brown G. P, Brown C. W., Jones J. C., Wood E. L., Sage I. C., Rudin J. ‘Grating Aligned Bistable Nematic Device’. SID Int. Symposium Digest XXVIII 37-40(1997). Another type is known as post aligned bistable nematic (PABN) device: Kitson S. and Geisow A. ‘Controllable alignment of nematic liquid crystals around microscopic posts: Stabilization of multiple states’. Appl. Phys. Lett., 80, 3635 (2002). The ZBD uses a monograting made out of a polymer that imparts homeotropic alignment to the LC or which is treated to impart this alignment. The PABN uses an array of posts made from a more conventional polymer that imparts a local planar alignment. In both cases the alignment changes from near planar at one surface to near vertical (homeotropic) at the other. Both microstructured surfaces are bistable In both cases. Switching is between two stable states: near-homeotropic (dark) and a hybrid homeoplanar (bright).

One version of the twisted ZBD device has a rubbed polyimide layer for the planar alignment on one side and a monograting on the opposite side, oriented normally to each other: C. Jones, P. Worthing, G. Bryan-Brown, E. Wood. ‘Transflective and single polarizer reflective ZBD’. SID'03 Digest, pp 190-193. The cell switches between initial twist and homeoplanar states.

Another bistable nematic device uses special alignment layers on opposite substrate surfaces, one of which provides a strong anchoring and the other of which provides weak anchoring: I. Dozov, M. Nobili and G. Durand. ‘Fast bistable nematic display using monostable surface switching’. Appl. Phys. Lett., 70, 9, 1997. pp 1179-1181. Patent Application No. US20010012080, ‘Bistable liquid crystal display device’, describes a bistable device which has vacuum oblique deposited SiO layers on both sides. The cell is filled with a liquid crystal with positive dielectric anisotropy. The device switches between planar and metastable twisted states. In order to make both states stable at zero field, a chiral dopant is used to induce a desired helical pitch. Although the SiO layers give a good controllable anchoring, the oblique deposition technology is not applicable for larger displays, as the anchoring has significant variation from side to side. For more practical applications a device uses a standard polyimide on one side in place of an SiO layer, and a specific polyimide material with weak anchoring on the other: Dozov, A. Boissier and T. Laboureau: ‘Nemoptic's bistable nematic liquid-crystal technology’, Information display, January 2002, pp. 10-12. This technology is similar to the standard twisted nematic technology with a polyimide layer and needs precise control over thickness and over the mechanical rubbing process, which makes it unattractive for application to plastic technology.

US 2005/0248702 describes a reflective bistable LCD which uses a chirally-doped nematic liquid crystal material between opposed substrates. One of the substrates has strong anchoring energy and a pre-determined pre-tilt angle, and the other substrate has shape anisotropy and a weak anchoring energy, and has a pre-tilt angle of about 0°.

### SUMMARY OF THE INVENTION

According to a first aspect of the invention there is provided a bistable liquid crystal display device comprising:
a first cell wall and a second cell wall enclosing a layer of a nematic liquid crystal material;
electrodes for applying an electric field across at least some of the liquid crystal material;
a first alignment structure on an inner surface of the first cell wall, comprising a grating which tends to induce adjacent molecules of the liquid crystal material to adopt a uniform planar alignment substantially without pre-tilt;
a second alignment structure on an inner surface of the second cell wall, comprising an array of posts or holes which tend to induce adjacent molecules of the liquid crystal material to adopt a uniform planar alignment with pre-tilt;
wherein the surface of the second alignment structure has a higher anchoring strength than does the surface of the first alignment structure;
and wherein two stable molecular configurations of the liquid crystal material can exist after suitable electrical signals have been applied to the electrodes.

We have found that this arrangement allows bistable switching between different optical states according to the nature of an applied voltage pulse. One or more of the polarity, amplitude and duration of the voltage pulse may be changed to effect bistable switching.

The posts or holes provide an alignment structure which has shape anisotropy, and the material from which the posts or holes are formed has strong anchoring energy.

Either or both of the alignment structures may be provided by embossing in a suitable polymer layer. The display may be fabricated over a large area by means of such embossing techniques, and it may be manufactured using plastic technology, i.e. from first and second cell walls made of a plastics material.

According to a second aspect of the present invention there is provided a bistable liquid crystal display device comprising a first cell wall and a second cell wall enclosing a layer of a nematic liquid crystal material, row and column electrodes for applying an electric field across at least some of the liquid crystal material, a first alignment structure on an inner surface of the first cell wall, comprising a grating which tends to induce adjacent molecules of the liquid crystal material to adopt a uniform planar alignment substantially without pre-tilt, a second alignment structure on an inner surface of the second cell wall, comprising an array of posts or holes which tend to induce adjacent molecules of the liquid crystal material to adopt a uniform planar alignment with pre-tilt, wherein the surface of the second alignment structure has a higher anchoring strength than does the surface of the first alignment structure, wherein two stable molecular configurations of the liquid crystal material can exist after suitable electrical signals have been applied to the electrodes, and further comprising a polarizer affixed to one of the cell walls and an analyzer affixed to the other cell wall, for optically distinguishing between the two molecular configurations.

According to a third aspect of the present invention there is provided a method of manufacturing a bistable liquid crystal display device, the method comprising providing a first cell wall having at least one electrode on a surface thereof, and having a first alignment structure on said surface, comprising a grating which tends to induce adjacent molecules of a liquid crystal material to adopt a uniform planar alignment substantially without pre-tilt, providing a second cell wall having at least one electrode on a surface thereof, and having a second alignment structure on said surface, comprising an array of posts or holes which tends to induce adjacent molecules of a liquid crystal material to adopt a uniform planar alignment with pre-tilt, wherein the surface of the second alignment structure has a higher anchoring strength than does the surface of the first alignment structure, arranging the first cell wall and the second cell wall parallel to each other and spaced apart, with said surfaces facing each other, filling the space between the cell walls with a nematic liquid crystal material, and providing a seal to retain the liquid crystal material between the cell walls, wherein two stable molecular configurations of the liquid crystal material can exist after suitable electrical signals have been applied to the electrodes.

According to a fourth aspect of the present invention there is provided a method for selecting a state of a bistable liquid crystal device, the device comprising first and second substantially parallel cell walls for the device arranged in spaced relation and adapted to enclose a layer of a nematic liquid crystal material therebetween, the first and second cell walls respectively comprising first and second alignment structures on an inner surface thereof adapted to cause a long axis of the molecules of said material to align substantially parallel to the cell walls, the method comprising applying of an electrical pulse to generate a potential difference between at least a portion of said first and second cell walls in order to cause a change of state of the device, the applied electrical pulse having a polarity and duration of application selected according to the required state.

In one embodiment, the liquid crystal material has positive dielectric anisotropy and at least one electrode is provided on each cell wall. Preferably a plurality of electrodes are provided on each cell wall, for example striped row electrodes on one wall and striped column electrodes on the other cell wall, with the row and column electrodes orthogonal to each other to permit matrix addressing in a manner well known per se in the art. For convenience, the invention will be described herein with reference to this embodiment, but it will be understood that other arrangements are possible within the ambit of the invention. For example, the liquid crystal may have negative dielectric anisotropy, and interdigitated electrodes may be provided on one or both cell walls, for applying an electric field substantially parallel to the surface of the cell walls.

Anchoring strength can be difficult to measure, but is generally correlated to surface energy, which may be measured using a water contact angle measurement. A typical surface energy measurement for a weak anchoring polymer is about 30 mN/m and a typical measurement for a strong anchoring polymer is about 54 mN/m.

The achievement of a tilted planar alignment using an array of posts or holes is known per se; see, for example U.S. Pat. No. 6,798,481 B2, US 2002/0196403 A1, and US 2005/0270461 A1, the contents of which are incorporated herein by reference. By selecting posts or holes of suitable dimensions, shapes and orientations, the degree of tilt can be varied and optimised for particular display requirements. It should be noted that, although surfaces textured with posts or holes can induce bistable alignment in which adjacent liquid crystal molecules can adopt either of two different tilt angles in the same aziumuthal plane (as discussed in the three above-referenced patent documents), such arrangements may not be necessary in the present invention, which may use an array of posts or holes which produce a monostable planar alignment with pre-tilt. Preferably the pre-tilt angle is less than 45°. In one embodiment, the pre-tilt angle is in the range 1-30°; in another embodiment the pre-tilt angle may be in the range 2-20°; in a further embodiment the pre-tilt angle may be in the range 3-10°.

The different molecular configurations may be optically distinguished by suitable distinguishing means well known to those skilled in the art of LCD manufacture. For example, the device may be provided with a polarizer on each cell wall, with the polarizers being set at a suitable angle to each other to distinguish the optical states. In one embodiment, the polarizers are orthogonal to each other. In another embodiment, the polarizers are parallel. In other embodiments, the liquid crystal material may have a pleochroic dye dissolved therein, optionally with one polarizer to increase the contrast ratio.

In the present invention, bistability is provided by the surface comprising an array of posts or holes. In response to an electric field, the molecular alignment may be switched between two stable alignments coinciding with a favoured direction, for example a diagonal of a post or hole. Although the bistable states are believed to differ in their twist profiles, the liquid crystal material need not be chiral to achieve these twist profiles. and preferably the liquid crystal material is substantially free from chiral dopant.

### BRIEF DESCRIPTION OF THE DRAWINGS

The invention will now be further described, by way of example only, with reference to the following drawings, in which:

FIG. 1 is a schematic cross section through a device in accordance with an embodiment of the present invention;

FIG. 2 shows details of the alignment structures of the device of FIG. 1;

FIG. 3, comprising FIGS. 3a and 3b, illustrates different optical states of a device in accordance with an embodiment of the invention;

FIG. 4 is a graph showing the electro-optical response of a the display device of FIG. 3; and

FIG. 5 is a graph of contrast ratio for an applied voltage for the display device of FIG. 3.

### DETAILED DESCRIPTION

It should be emphasised that the term “comprises/comprising” when used in this specification specifies the presence of stated features, integers, steps or components but does not preclude the presence or addition of one or more other features, integers, steps, components or groups thereof.

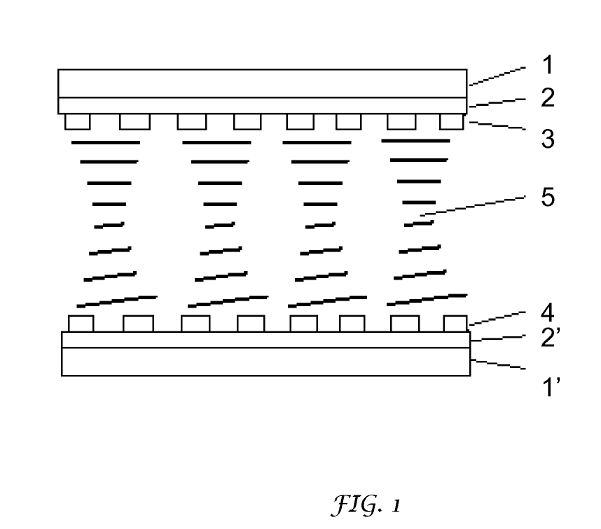

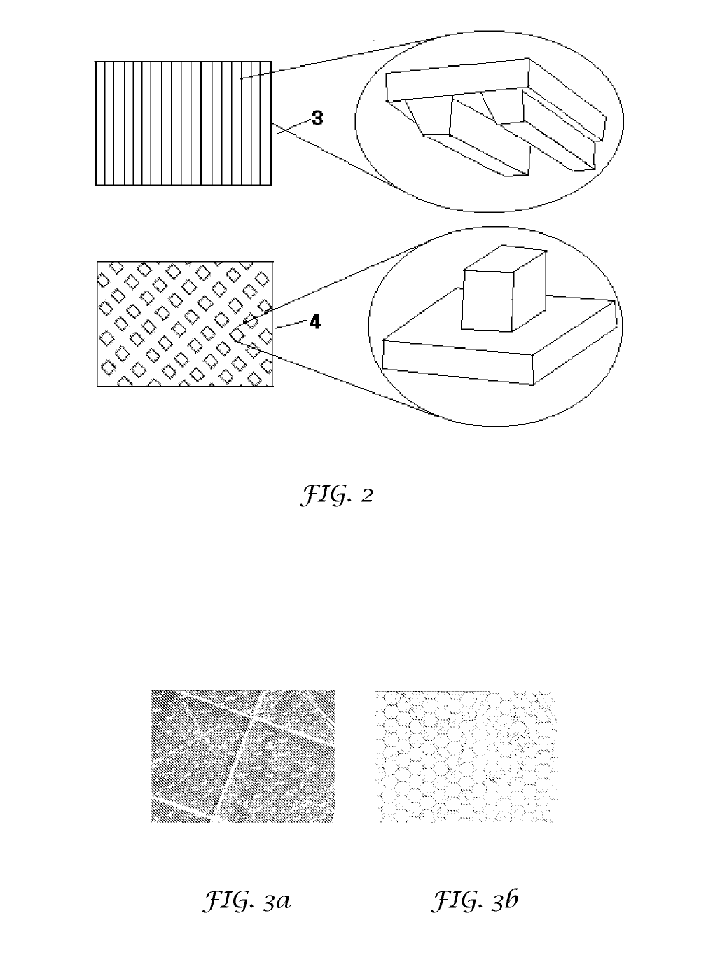

In the drawings of FIGS. 1 and 2, different parts have been enlarged or reduced to aid illustration of the invention. The drawings are therefore not to scale.

In the following description, percentage compositions are expressed by weight unless the context requires otherwise.

The bistable liquid crystal device shown in FIG. 1 comprises a first cell wall 1 and an opposed second cell wall 1′. Each cell wall has a respective electrode structure 2, 2′, in this example made of indium tin oxide (ITO), on an inner surface. The cell walls 1, 1′ are formed from a plastics material, for example PET, PES or PEEK, but either or both could alternatively be made of glass. The cell walls 1, 1′ enclose a layer of a nematic liquid crystal material 5. An inner surface of the first cell wall 1 is provided with a first alignment structure 3, which in this embodiment is formed by embossing a low anchoring energy (about 8-12 V/μm) polymeric material. As shown in FIGS. 2a and 2b, the first alignment structure 3 is a monograting of wall structures having a pitch of about 1.2 μm, with equal wall to space ratio and a height of about 1 μm. The first alignment structure 3 induces adjacent molecules of the liquid crystal material 5 to adopt a uniform planar alignment (parallel to the plane of the cell walls 1) substantially without pre-tilt.

A second alignment structure is provided on an inner surface of the second cell wall 1′. As shown in FIGS. 2c and 2d, in this embodiment the second alignment structure comprises a two-dimensional array of posts 4 formed by embossing a high anchoring energy (about 50-70 V/μm) polymeric material. The array may be regular or it may be random or pseudorandom, as is known per se in the art. The posts 4 are about 0.6 μm square and about 1.2 μm high, with a tilt of about 6° from perpendicular to the plane of the inner surfaces of the cell walls. In an alternative embodiment (not shown) the second alignment structure could comprise an array of holes of the same or similar dimensions and orientation to the posts and formed from the same high anchoring energy material. It is preferred that the posts or holes are dimensioned or oriented to favour a single azimuthal alignment direction. This may be achieved by tilting (as in the present embodiment) or by forming the posts or holes in a non-tilted asymmetric shape such as a ‘teardrop’ shape or a kite shape. The second alignment structure 4 induces adjacent molecules of the liquid crystal material 5 to adopt a uniform planar alignment. The second alignment layer therefore has a combination of shape or tilt anisotropy and high anchoring energy.

The first and second alignment structures have been illustrated as being formed on the respective electrodes 2, 2′. However, it will be understood that some or all parts of an individual element of the alignment structures (walls, posts, or holes) may be formed wholly or partially directly on its associated cell wall, depending on the shape of the electrode structures 2, 2′.

We determined the anchoring energy of the polymers by investigations of an antiparallel planar cell, one side of which was covered with rubbed standard polyimide AL1254 with strong anchoring and the opposite side was covered with the polymer layer to be tested. This polymer layer was also rubbed. The cell was filled with 5CB, a nematic liquid crystal material of positive dielectric anisotropy. The cell was placed between crossed polarizers, in such way that the director was parallel to one of polarizers. In this configuration, any change in tilt angle due to an applied field does not produce an optical response because it does not produce a change in retardation. If a sufficient voltage is applied to the cell so that it breaks the anchoring strength close to the side with the tested polymer, the back flow, induced from the side with strong anchoring (due to quick reorientation of molecules under anchoring of the rubbed polyimide) will force a twisted state. Consequently this state between crossed polarizers exhibits an optical response caused by the twist. The threshold voltage, under which the cell optically responds, is a measure of the anchoring strength of the tested polymers (it is generally known that standard rubbed polyimide needs more than 50 V/μm for anchoring breaking, which means 250 Volt for a 5 μm cell). We used this technique to measure the threshold voltage needed to break the anchoring of the polymers used for embossing, and the results are given in Table 1. (Anchoring energy W and electrical field E=V/d can be approximately linked as:

W=E(∈ₒΔ∈K)^{1/2}, V—voltage, Δ∈—dielectric anisotropy, K—elastic constant).

TABLE 1

| Polymer Anchoring | Applied Voltage | | | | Experimental |
|---|---|---|---|---|---|
| Strength | cell thickness | | Electrical Field | | Cell |
| Weak | 43–75 | V | 8–15 | V/μm | HP4071 |
| | 5 | μm | | | |
| Strong | >220 | V | >45 | V/μm | HP4069 |
| | 5 | μm | | | |

By tuning the formulation of the polymer material one can vary the strength with which the LC molecules are anchored to the surface. We investigated cells with different combinations of the microstructured surfaces, embossed into these different polymers. The planar alignment direction induced by the monograting is aligned with that induced by the posts or holes, although the relative alignments can be varied in other embodiments of the invention. Results are given in Table 2.

TABLE 2

| | | applied | | | |
|---|---|---|---|---|---|
| | polymer | voltage/ | | | |
| Combination | anchoring | pulse length | | switching | cells |
| posts | strong | 40–80 | V | good | HP4150 |
| monograting | weak | 0.1–0.2 | ms | uniform | HP4156 |
| | | | | bistable | |
| holes | strong | 40–80 | V | good | HP4204 |
| monograting | weak | 0.1–0.2 | ms | uniform | HP4207 |
| | | | | bistable | |
| posts | weak | 125 | V | non-uniform | HP4177 |
| monograting | strong | 5 | ms | | |
| monograting | strong | 21 | V | non-uniform | HP4162 |
| monograting | weak | 1 | ms | reverse twist | |
| posts | strong | 150 | V | non-uniform | HP4161 |
| monograting | strong | 5 | ms | | |

The thickness of the experimental cells was controlled by a polymer honeycomb-like spacer 6 (best shown in FIG. 3b), embossed with the monograting surfaces and varied between 1-10 μm. Commercial nematic LCs E7 (Merck), ROTN-403 (La-Roche) were used, both of which have positive dielectric anisotropy. In order to decrease the interaction of the LC molecules with the microstructured surfaces, an oligomer, in these examples from 1-10% of Sartomer SR349 was added to the nematic LCs. Unipolar pulses with amplitude 10-80 V were applied, with pulse durations from 0.1-50 ms. For the experimental cells of Table 2, a monograting of 0.6 μm pitch was used, with a 2 μm spacer. The LC was E7 containing 4% Sartomer SR349.

Initially, the cell is placed between crossed polarizers in such a way that the light transmission is minimal (FIG. 3a). This is achieved by aligning the cell's director parallel to the input polarizer and setting the rotation of the analyzer at an appropriate angle, typically 90° to the polarizer. We found that the switching very strongly depends on the polarity of an applied pulse. A preferable regime of switching is achieved when a positive pulse is applied to the second electrodes 2′ (i.e., to the side of the cell wall with the posts or holes formed from a material of high anchoring strength), under which the cell switches to the light state (FIG. 3b).

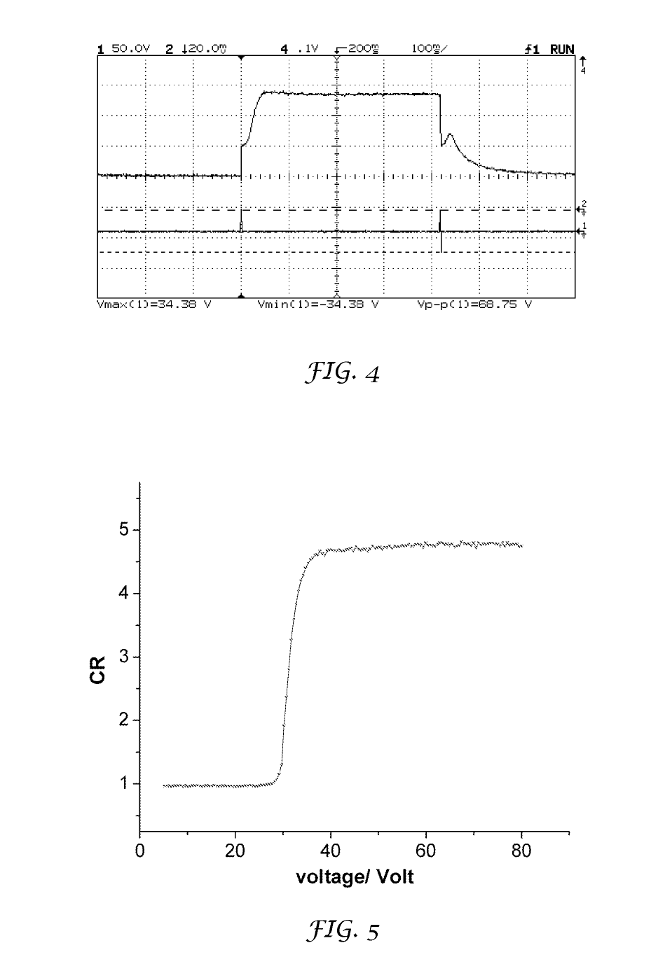

An examination under crossed polarizers shows that the light state is the twisted state. The back switching is provided by applying the same polarity pulse but with a different length. Our investigations show that the shape of the posts/holes quite strongly influences the switching performance, the bistability and the optics of the cell. FIG. 4 shows the electro-optical response of the bistable switching in a planar cell with nematic LC E7 doped by 4% Sartomer SR349. The switching shows a good threshold (FIG. 5), which enables passive matrix addressing of the display.

Without wishing to be bound by theory, we believe that in the present invention molecules of the liquid crystal material have two stable planar states, which differ in their twist profiles. When used with polarizers, this gives an inherently good viewing angle cone. With the alignment directions on the two surfaces aligned to be parallel, then one state is untwisted and the other is twisted. However it is not clear whether the twist is 90° or 180° or some other angle. In addition it is possible that the tilt may be different in the two states, as with other post-aligned bistable devices. Sign dependence in the switching behaviour indicates that flexoelectricity and surface polarizing effects, caused by the strong asymmetry of the cell, may play a role in the switching mechanism. It is well known that in conventional bistable twisted nematic devices the switching is strongly influenced by flow in the LC while the voltage is applied. In particular, back-flow can influence the switching directions.

What is claimed is:

1. A bistable liquid crystal display device comprising:
a first cell wall and a second cell wall enclosing a layer of a nematic liquid crystal material;
electrodes for applying an electric field across at least some of the liquid crystal material;
a first alignment structure on an inner surface of the first cell wall, comprising a grating which tends to induce adjacent molecules of the liquid crystal material to adopt a uniform planar alignment substantially without pre-tilt;
a second alignment structure on an inner surface of the second cell wall, comprising an array of posts or holes which tend to induce adjacent molecules of the liquid crystal material to adopt a uniform planar alignment with pre-tilt;
wherein the surface of the second alignment structure has a higher anchoring strength than does the surface of the first alignment structure;
and wherein two stable molecular configurations of the liquid crystal material can exist after suitable electrical signals have been applied to the electrodes.

2. A device according to claim 1, wherein the direction of planar alignment induced by the first alignment structure is substantially parallel to the direction of planar alignment induced by the second alignment structure.

3. A device according to claim 1, wherein the nematic liquid crystal material is substantially free from any chiral dopant.

4. A device according to claim 1, wherein the surface of the first alignment structure has an anchoring strength in the range 6-15 volt/μm.

5. A device according to claim 1, wherein the surface of the second alignment structure has an anchoring strength in the range 30-70 volt/μm.

6. A device according to claim 1, wherein the posts or holes are tilted relative to the normal to the plane of the inner surface of the second cell wall.

7. A device according to claim 1, wherein the posts or holes have an asymmetric sectional shape.

8. A device according to claim 1, wherein the posts or holes are dimensioned or oriented to favour a single azimuthal alignment direction of adjacent molecules of the nematic liquid crystal material.

9. A device according to claim 1, wherein the two stable molecular configurations are planar alignments which have different twist profiles.

10. A device according to claim 1, wherein the surface of the first alignment structure has a surface energy value in the range 20-40 mN/m and the surface of the second alignment structure has a surface energy value in the range 44-64 mN/m.

11. A method of addressing the display device of claim 1, the method comprising applying electrical pulses across at least two of the electrodes, the pulses having positive polarity at an electrode on the second cell wall.

12. A method according to claim 11, wherein bistable switching between the two molecular configurations is achieved by varying the polarity of the electrical pulse.

13. A method of manufacturing a bistable liquid crystal display device, the method comprising:
providing a first cell wall having at least one electrode on a surface thereof, and having a first alignment structure on said surface, comprising a grating which tends to induce adjacent molecules of a liquid crystal material to adopt a uniform planar alignment substantially without pre-tilt;
providing a second cell wall having at least one electrode on a surface thereof, and having a second alignment structure on said surface, comprising an array of posts or holes which tends to induce adjacent molecules of a liquid crystal material to adopt a uniform planar alignment with pre-tilt;
wherein the surface of the second alignment structure has a higher anchoring strength than does the surface of the first alignment structure;
arranging the first cell wall and the second cell wall parallel to each other and spaced apart, with said surfaces facing each other;
filling the space between the cell walls with a nematic liquid crystal material; and
providing a seal to retain the liquid crystal material between the cell walls;
wherein two stable molecular configurations of the liquid crystal material can exist after suitable electrical signals have been applied to the electrodes.

14. A method according to claim 13, further comprising aligning the cell walls so that the direction of planar alignment induced by the first alignment structure is substantially parallel to the direction of planar alignment induced by the second alignment structure.

15. A method according to claim 13, wherein the surface of the first alignment structure has an anchoring strength in the range 6-15 volt/μm and the surface of the second alignment structure has an anchoring strength in the range 30-70 volt/μm.

16. A method according to claim 13, wherein the posts or holes are tilted relative to the normal to the plane of the inner surface of the second cell wall.

17. A method according to claim 13, wherein the posts or holes have an asymmetric sectional shape.

18. A method according to claim 13, wherein at least one of the first alignment structure and the second alignment structure is formed by embossing a layer of a plastics material on the first cell wall or the second cell wall.

19. A method according to claim 13, wherein the surface of the first alignment structure has a surface energy value in the range 20-40 mN/m and the surface of the second alignment structure has a surface energy value in the range 44-64 mN/m.

20. A method for selecting a state of a bistable liquid crystal device, the device comprising:
first and second substantially parallel cell walls for the device arranged in spaced relation and adapted to enclose a layer of a nematic liquid crystal material therebetween, the first and second cell walls respectively comprising first and second alignment structures on an inner surface thereof adapted to cause a long axis of the molecules of said material to align substantially parallel to the cell walls, the method comprising:
applying of an electrical pulse to generate a potential difference between at least a portion of said first and second cell walls in order to cause a change of state of the device, the applied electrical pulse having a polarity and duration of application selected according to the required state.
